(19) United States
(12) Patent Application Publication
(10) Pub. No.: US 2010/0027966 A1
(43) Pub. Date: Feb. 4, 2010

(54) SYSTEMS AND METHODS FOR VIDEO BOOKMARKING

(75) Inventors: Jeffrey Paul Harrang, Sammammish, WA (US); David B. Gibbons, Redmond, WA (US)

Correspondence Address: Jeffrey Paul Harrang, Suite 2200, 1201 Third Avenue, Seattle, WA, 98101, US

(73) Assignee: Opanga Networks, LLC, Seattle, WA (US)

(21) Appl. No.: 12/535,508

(22) Filed: Aug. 4, 2009

Related U.S. Application Data
(60) Provisional application No. 61/086,104, filed on Aug. 4, 2008.

(51) Int. Cl. H04N 5/91; H04N 7/173

(52) U.S. Cl. 386/69; 725/116

(57) ABSTRACT

A video content distribution system includes a remote content server, a communications network, and multiple media playback devices. One of the media playback devices generates a place marker that indexes a location in a video content where to resume playback of the video content and then the media playback device stores the place marker locally in the communications network. Subsequently, the same media playback device connects to the remote content server and stores a copy of the place marker remotely in the communications network.

### CROSS REFERENCE TO RELATED APPLICATIONS

The present application claims the benefit of U.S. Provisional Application No. 61/086,104, filed Aug. 4, 2008.

### FIELD OF THE INVENTION

The present invention generally relates to systems and methods for bookmarking video content. One or more users sharing access to the same video content library may create place markers indexing locations in select video content where to resume playback at a later time, and then store the place marker(s) both locally on their media playback device(s) and remotely on a content server. Registered users having access to the video content library can then retrieve the place marker(s) and resume playback of the video content from the same or different media playback device(s).

### BACKGROUND OF THE INVENTION

With the increasing popularity of digital video recording devices (DVRs such as Tivo™ devices), consumers are generating a high demand for more flexible, robust technologies directed at controlling video playback using their existing personal computing devices. Some of these personal computing devices include personal desktop computers, laptop computers, mini-computers, cellular phones and mobile internet devices, televisions, DVRs, digital cable boxes, DVD and Blu-ray™ devices, video game consoles, and portable video players. Modern video recording and bookmarking technologies allow a user to utilize a local mass storage device, such as a hard drive and/or a buffer to locally record and save a place-marker indicating a location in a streaming video content where a user wishes to resume playback at a later time.

Unfortunately, these technologies are short-sighted and typically focus on individual users viewing a select video content from only one media playback device. For example, when more than one user is watching a video content on their media playback device (e.g., a television or a portable media player), those users can only locally save a place marker for one user viewing activity at a time. More specifically, in a scenario where one user watches the first 20 minutes of a movie and then goes to bed, while a second user (watching the same video from same playback device) stays up and watches the first hour of the movie (an additional 30 minutes of viewing) before going to bed, both users would be unable to save their particular viewing place markers for the same movie and associate their respective place markers with their individual or shared viewing accounts. Further, which ever of the two users bookmarked the video on the playback device would only be able to resume watching the video on the same playback device.

Accordingly, it would be advantageous to have a more powerful video bookmarking system that would allow multiple users to establish individual or shared viewing accounts at both remote and local device locations, such that any user of any video content could resume playback of their own video content at whatever location their video place markers were generated within their video content. It would also be beneficial if the improved video bookmarking system facilitated a user accessing their place marker(s) and associated video content on any of playback device of their choosing.

### SUMMARY OF THE INVENTION

In overcoming the above disadvantages associated with existing video content distribution systems, the present invention discloses a system that includes a remote content server, a communications network, and multiple media playback devices. One of the media playback devices generates a first place marker that indexes a first location in a video content where to resume playback of the video content, and then the media playback device stores the first place marker locally in a first portion of the communications network.

In accordance with another aspect of the invention, the media playback device connects to the remote content server and stores a copy of the first place marker in a second portion of the communications network.

In accordance with a further aspect of the invention, the first portion of the communications network is a local area network (LAN) location and the second portion of the communications network is a wide area network (WAN) location.

In accordance with yet another aspect of the invention, a second playback device of the multiple media playback devices accesses the copy of the first place marker and resumes playback of the video content at the indexed first location in the video content.

In accordance with another aspect of the invention, the second playback device generates a second place marker that indexes a second location in the video content and then stores the second place marker both locally on the second playback device and remotely as a copy on the remote content server.

In accordance with a further aspect of the present invention, the first playback device accesses the copy of the second place marker on the remote content server and resumes playback of the video content at the indexed second location in the video content.

In accordance with another aspect of the invention, the first playback device also stores a set of user access rights that comprise information pertaining to which users have access to which media content and which place markers.

In accordance with yet a further aspect of the present invention, is a computer-readable medium is encoded with computer executable instructions, which when executed, perform a method including generating at a first media playback device, a first place marker that indexes a first location in a video content where to resume playback of the video content, and storing the first place marker locally in a first portion of a communications network in response to the generation of the first place marker.

In accordance with yet another aspect of the present invention, is a computer implemented method including generating at a first media playback device, a first place marker that indexes a first location in a video content where to resume playback of the video content, and storing the first place marker locally in a first portion of a communications network in response to the generation of the first place marker.

### DESCRIPTION OF THE DRAWINGS

Preferred and alternative examples of the present invention are described in detail below with reference to the following Figure drawings:

FIG. 1 illustrates a perspective view of a video content distribution system in accordance with an embodiment of the present invention;

FIG. 2 illustrates a block diagram of a server store in accordance with an embodiment of the present invention;

FIG. 3 illustrates a block diagram of a media playback device in accordance with an embodiment of the present invention;

FIG. 4 illustrates a first portion of a flow diagram of a video bookmarking process in accordance with an embodiment of the present invention;

FIG. 5 illustrates a second portion of a flow diagram of a video bookmarking process in accordance with an embodiment of the present invention;

FIG. 6 illustrates a third portion of a flow diagram of a video bookmarking process in accordance with an embodiment of the present invention; and

FIG. 7 illustrates a fourth portion of a flow diagram of a video bookmarking process in accordance with an embodiment of the present invention.

### DETAILED DESCRIPTION

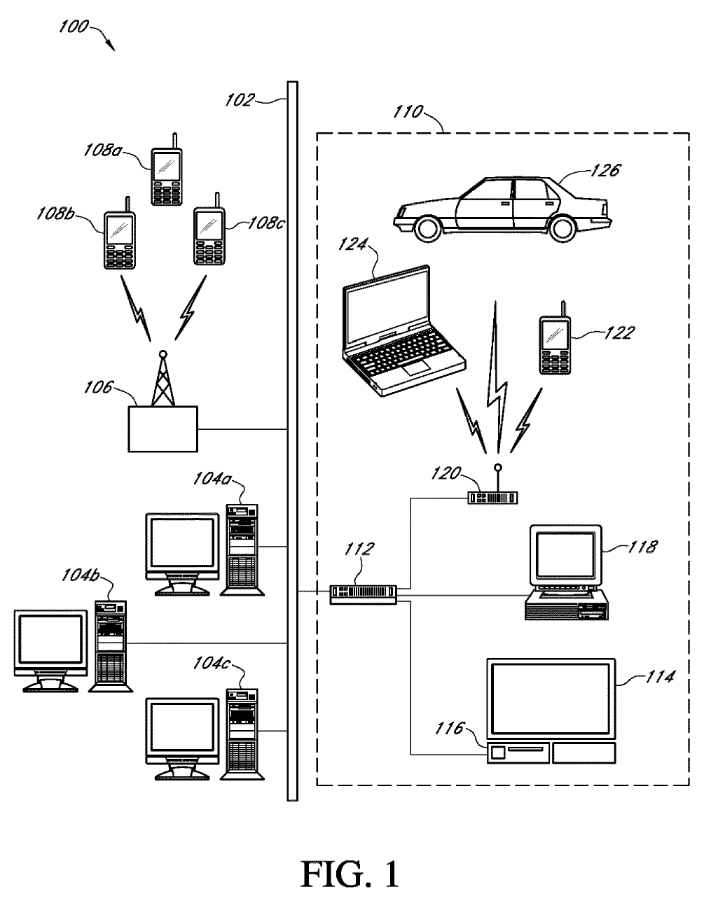

In accordance with an exemplary embodiment of the present invention, FIG. 1 illustrates a distributed computing system 100 including various wireline and wireless computing devices that may be utilized to implement any of the video bookmarking processes associated with various embodiments of the present invention. The distributed computing system 100 may include, but is not limited to, a group of server devices 104a-c, any one of which may be associated with a remote or local server store that can provide video distribution services to various networked clientele; a communications network 102 (hereafter, also referred to as a WAN); one or more remote client devices 108a-c that may be connected to the communications network 102 utilizing a wireless basestation 106 or any common cable network technology; one or more gateway devices 112 that can facilitate communications between the WAN 102 and the LAN 110; a television device 114 (e.g., a high-definition LCD or Plasma television) that is connected to a video playback device 116, which may include a digital video recorder (DVR), a Blu-ray™ player, or digital video disk (DVD) player/recorder; a personal desktop computer 118; a wireless router 120 that may communicate with various wireless LAN 110 devices using any common local wireless communications technology, such as Wi-Fi or unshielded twisted pair cable; a wireless laptop computer 124; a personal digital assistant (PDA) device 122; and an automobile 126 having wireless communications technology and optionally various media playback devices (e.g., seatback video player devices, not shown).

In an embodiment, the server devices 104a-c, the wireless basestation 106, the remote client devices 108a-c, and any of the LAN 110 connected devices 112, 114, 116, 118, 120, 122, 124, and 126, may be configured to run any known operating system, including but not limited to, Microsoft Windows™, Mac OS™, Linux™, Unix™, or any common mobile operating system, including Symbian™, Palm™, Windows Mobile™, Mobile Linux™, MXI™, etc. In an embodiment, the server devices 104a-c, the wireless basestation 106 as well as any of the remote client devices 108a-c may employ any number of common server, desktop, laptop, and personal computing devices. In an embodiment, the remote client devices 108a-c and any of the LAN 110 connected devices 114, 116, 118, 122, 124, and 126 may include any combination of mobile computing devices (e.g., cellular phones, PDAs, eBooks, ultra-portable computers, personal music players, etc.), having wireless communications capabilities utilizing any common cellular data commutations protocol, such as GSM, UMTS, WiMAX, Wi-Fi, or LTE protocols. In one particular embodiment the LAN 110 connected devices 114, 116, 118, 120, 122, 124, and 126 may communicate amongst each other and with the gateway device 112 using a local Wi-Fi enabled communications network. In this embodiment, all of the LAN 110 connected devices 112, 114, 116, 118, 120, 122, 124, and 126 may be Wi-Fi Certified™ devices.

In an embodiment, the WAN 102 may include, but is not limited to, any of the following communications technologies: optical fiber, coaxial cable, twisted pair cable, Ethernet cable, power-line cable, and any wireless technology known in the art. In an embodiment, any of the server devices 104a-c, the wireless basestation 106, the remote client devices 108a-c, and any of the LAN 110 connected devices 112, 114, 116, 118, 120, 122, 124, and 126, may include any standard computing software and hardware necessary for processing, storing, and communicating data amongst each other within the distributed computing system 100. The computing hardware may include, but is not limited to, one or more processors, volatile and non-volatile memories, user interfaces, transcoders, and wireline and/or wireless communications transceivers.

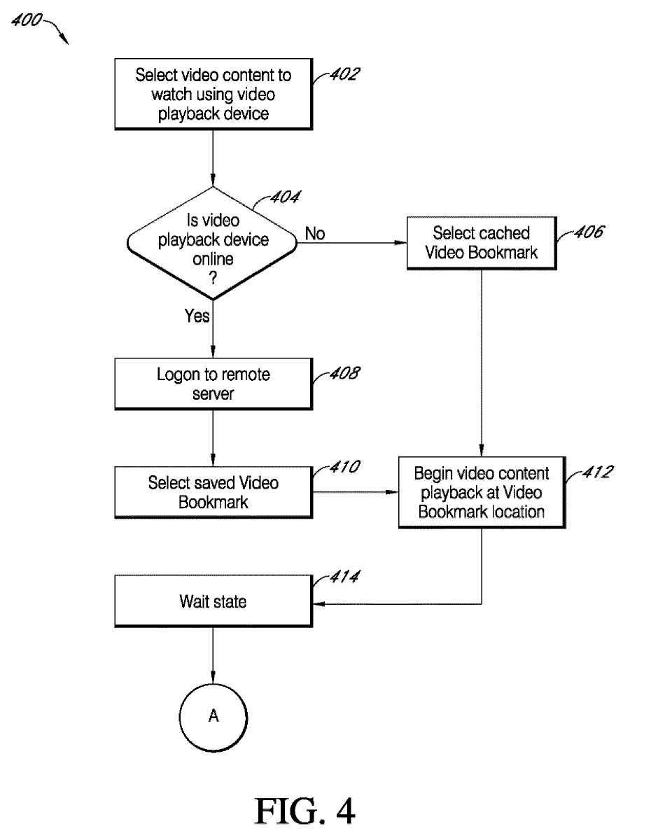

In an embodiment, a server device 104a-c and any of the media playback devices 108a-c, 114, 116, 118, 122, 124, and 126 of the distributed computing system 100 may be configured to include a computer-readable medium (e.g., any common volatile or non-volatile memory type) encoded with a set of computer-readable instructions, which when executed, performs one or more video bookmarking processes of the present invention. It should be understood that video bookmarks (also referred to as “place markers”), as described herein, are virtual place holders for video playback sessions that allow users to watch a portion of a video feature, pause the session, and resume the session later, picking up where they left off (e.g., within one or two seconds of where a playback was stopped during an original media viewing session). Video bookmarks maintain state information that can be applied to multiple media playback devices and multiple users sharing access to the same video content library. It should also be understood that any of the video bookmarking processes associated with the present invention may occur entirely within the WAN 102, entirely within the LAN 110, or within portions of both the WAN 102 and the LAN 110. These processes may occur simultaneously or in separate process steps that may be logically ordered according to any of the flow diagram processes of FIGS. 4-7.

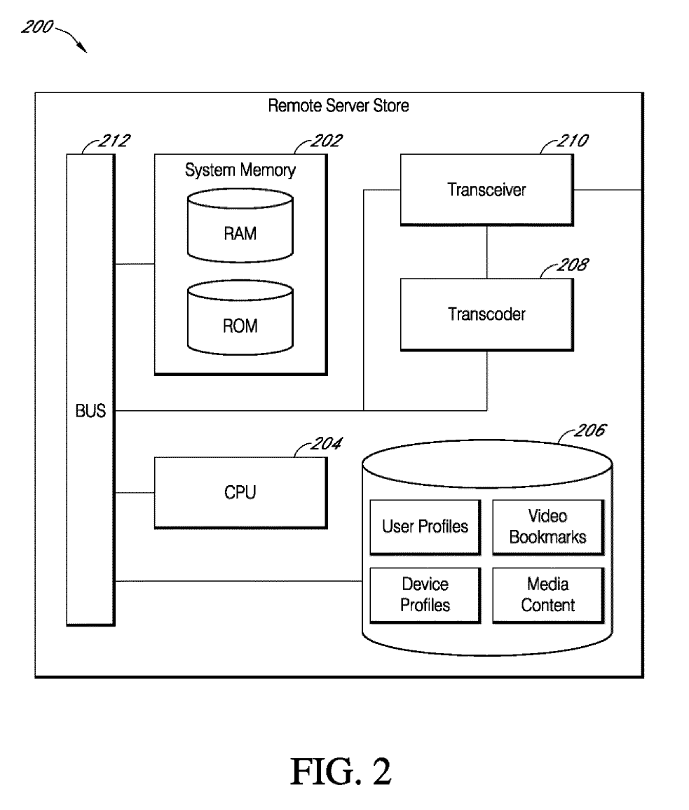

FIG. 2 shows a block diagram view of a server store device 200 that may be representative of any of the server devices 104a-c in FIG. 1 (Optionally, in various embodiments, the server store may reside entirely within a LAN 110, depending on a network system architecture). In an embodiment, the server store device 200 may include, but is not limited to, one or more processor devices including a central processing unit (CPU) 204. In an embodiment, the CPU 204 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 204 is primarily responsible for executing all computer programs stored on the server store device device's 200 volatile (RAM) and nonvolatile (ROM) system memories 202. The server store device 200 may also include: a remote content database 206 that includes repositories for user profiles, device profiles, video bookmarks, as well as various video content; a transcoder 208 for formatting video content, and a transceiver 210 for transmitting and receiving data over the WAN 102 and the LAN 110 of FIG. 1.

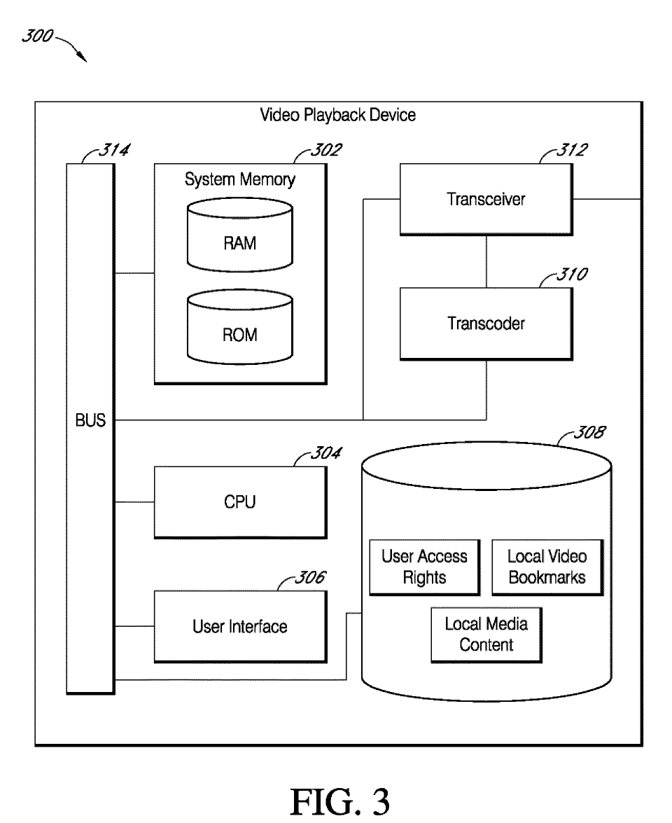

FIG. 3 shows a block diagram view of a video playback device 300. In an embodiment, the video playback device 300 may include, but is not limited to, one or more processor devices including a central processing unit (CPU) 304 that is primarily responsible for executing all computer programs stored on the relay device's 300 volatile (RAM) and nonvolatile (ROM) system memories 302; a user interface 306 that allows one or more users to view video content and input various data, including video bookmark information; a local content database 308 that includes repositories for local media content, local video bookmarks, and user access rights that permit certain users to access specified video and video bookmark content within either the local content database 308 or the content database 206 of the server store device 200; a transcoder 310 for formatting a video content; and one or more transceivers 312 for transmitting and receiving data within the LAN 110 and across the WAN 102 of FIG. 1.

Video bookmarks may consist of per-user and per-content playback state information collections maintained online via web services with persistent storage databases, and accessible from any playback device (e.g., any of playback devices 108a-c, 114, 116, 118, 122, 124, and 126) that is intermittently and/or continuously connected via a network to the server (e.g., any of the server devices 104a-c acting as a server store device 200) maintaining the web services. In an embodiment, if a playback device is online when a playback session is paused, the playback device may automatically contact the server store 200 and register the state of the playback session and the identity of the user in a video bookmark. Alternately, when a device goes online it may automatically contact the server and registers the state of any paused video playback sessions in its local content library remotely 206 or locally 308. Each paused video may generate a separate video bookmark associated with a particular playback session.

In an embodiment, if a playback device (e.g., any of playback devices 108a-c, 114, 116, 118, 122, 124, and 126) is offline when a playback session is paused, it may automatically save any video bookmarks associated with the playback device in its local memory 308. Later, when the playback device goes online, it automatically contacts the server store (e.g., any of the server devices 104a-c acting as a server store device 200) and registers the state of the playback session in a video bookmark associated with the playback session.

In an embodiment, finishing a playback session by reaching the end of the content clears any video bookmarks associated with a media content file and user. If the playback device (e.g., any of playback devices 108a-c, 114, 116, 118, 122, 124, and 126) is online when the playback session terminates, then the playback device may automatically contact the server store 200 and optionally clear the video bookmarks associated with the playback session and the identity of the user. Alternately, if the playback device is offline when the playback session terminates, then the playback device may mark the video bookmarks associated with the playback device in a local memory 308. Later, when the playback device goes online, it may automatically contact the server 200 and register the state of the playback session in a video bookmark associated with the session and optionally clear the video bookmarks associated with the playback session and the identity of the user.

The server store 200 may also similarly maintain the specific list of media content files in each playback device's local storage 308. Whenever the playback device is online it may periodically and automatically register its list of media content files with the server store 200. In an embodiment, attempting to resume a playback session on a playback device that does not have access to the media content (either physically or by account access permissions) may fail permanently.

In an embodiment, for shared multi-user playback devices, such as the television 114 of FIG. 1, video bookmarks may be optionally updated whenever the playback session is paused. The web services server (e.g., any of servers 104a-c) can maintain a list of users associated with shared media playback devices. User names associated with each playback device can be modified by an associated administrative user by adding, deleting, renaming users in a user registry stored in memory (e.g., user profiles in remote 206 or local 308 memories). In an embodiment, when a playback session is paused the user(s) may be presented with an option to set a video bookmark for one or more users according to a list of users associated with the media playback device.

In accordance with an embodiment of the invention, there may be various restrictions on operation in order for the video bookmarking processes of the present invention to function: resuming playback on different playback devices requires that the same content file is accessible (physically present, DRM authorized, service authorized, etc.) from each playback device; the video bookmark state information must be maintained online in order to be accessible to multiple devices regardless of their network attachment location (e.g. a server on the public Internet associated with a unique network address); during a time when a playback session is paused (or shortly after a playback session is paused) on a playback device, the device must go online for at least a short period (e.g., a period of a few minutes) in order to register its playback state with a server store (this is known as a video bookmark “capture”) before resuming on a separate playback device; when a playback session is resumed (or sometime after a playback session is resumed) on a playback device, the playback device must go online for at least a short period of time (e.g., for a few minutes) in order to register with the server store to obtain the playback state (this is known as a video bookmark “retrieve” function)—however no server registration/retrieval is required if the pause/resume is on the same device's video bookmarks (if they are individual), so if multiple users pause a playback session on a shared device (e.g., television 114) then each user should optionally register their presence in order to maintain their own video bookmark for future playback sessions.

FIGS. 4-7 illustrate flow diagrams of portions of a video bookmarking process 400, 500, 600, and 700 (from the perspective of a playback device) in accordance with an embodiment of the present invention. It should be understood that this process 400, 500, 600, and 700 could be executed using one or more computer-executable programs stored on one or more computer-readable mediums located on either the server store device 200 or any of the LAN 110 connected devices 112, 114, 116, 118, 120, 122, 124, and 126. At block 402, a user or group of users may begin a playback session by selecting the content they wish to watch using a graphical user interface (GUI) presented on the playback device which indicates available media content, and a controller such as an ordinary remote control or integrated hardware or software keypad GUI.

When the user commands the device to play, a video bookmark algorithm first determines whether the playback device is connected online to the server store 200 providing video bookmark web services at block 404. If the playback device is offline the locally cached video bookmark store is searched and if there are video bookmarks for a media content file the user may be presented with a selection choice of which video bookmark to use at block 406. If the device has only a single user associated with it (e.g. a laptop or other personal device) the video bookmark associated with the single user and media content file is automatically selected without user intervention. If the playback device has multiple users associated with it (e.g. family television or other multi-user device) the user is presented with a list of the available video bookmarks, for instance with a GUI on the playback device, and the user may select the appropriate video bookmark or chooses an option to clear the VB and begin viewing the content from the beginning.

In an embodiment, if the device is online the device logs on to the server store 200 at block 408 to access a video bookmark web service. The server's video bookmark repository 206 is searched and if there are video bookmarks for the media content file the user may be presented with a selection choice of which video bookmark to use 410. If the device has only a single user associated with it (e.g., a laptop 124 or a PDA 122) the video bookmark associated with the user and media content file may be automatically selected without user intervention. If the device has multiple users associated with it (e.g. family television 114) the user is presented with a list of the available video bookmarks, for instance, with a GUI on the playback device where a user is capable of selecting an appropriate video bookmark.

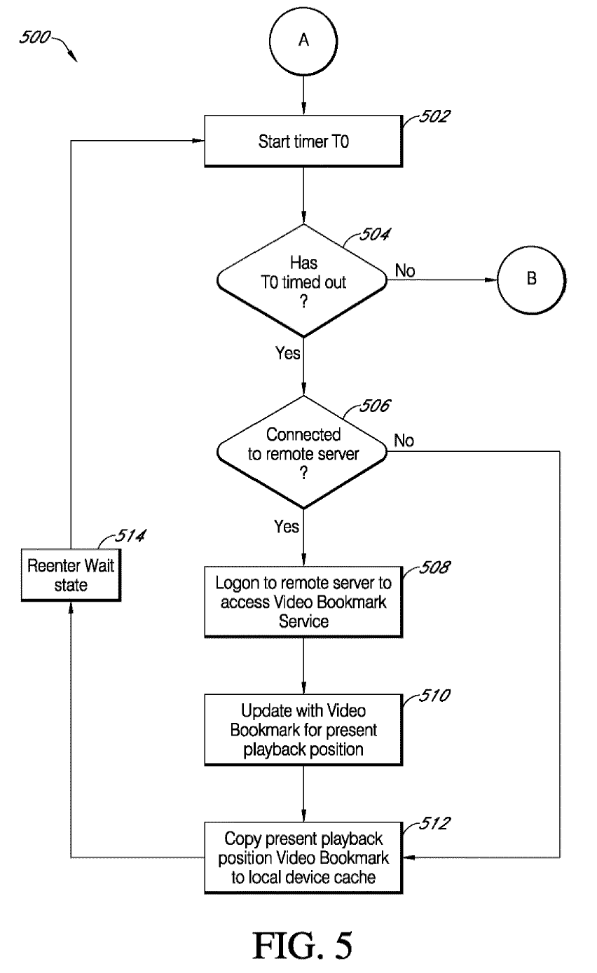

Once the appropriate video bookmark is determined (assuming any video bookmarks are present) the playback position in the media content file is set and the playback begins 412 and the algorithm enters the wait state 414 and starts a timer T0 502 of FIG. 5. If the timer T0 expires 504 before the user has paused the playback, or the playback has completed, or the playback has otherwise terminated (e.g. during a power failure), then the device checks to see if it is connected online to the server store 200 providing video bookmark web services 506. In an embodiment, timer T0 controls how much of the media content file a user would have to re-watch, worst-case, if the playback session were unexpectedly interrupted just before T0 expired while in the wait state 414, for instance T0=10 minutes.

In an embodiment, if the playback device is online, the playback device logs on with the server 200 to access the video bookmark web service 508 if it is not currently logged on. The server's video bookmark repository 206 is updated with a video bookmark for the present playback position 510 in the media content file using a default user ID associated with the playback device. At block 512, the playback device's local video bookmark cache 308 is also updated with a copy of the same video bookmark. The purpose of this video bookmark is to enable a memory of the latest playback position in the media content file, so that if the playback is unexpectedly interrupted (e.g., during a power failure, etc.), the user could resume playback at the point of interruption by using the video bookmark associated with the default user of the device. The device then logs off the server and reenters the wait state 514 and rearms the timer T0 502. However, if the device is offline, the device's local video bookmark cache 308 is updated with the video bookmark 512 for the present playback position in the media content file using a default user ID associated with the playback device. The playback device then reenters the wait state 514 and rearms the timer T0 (502).

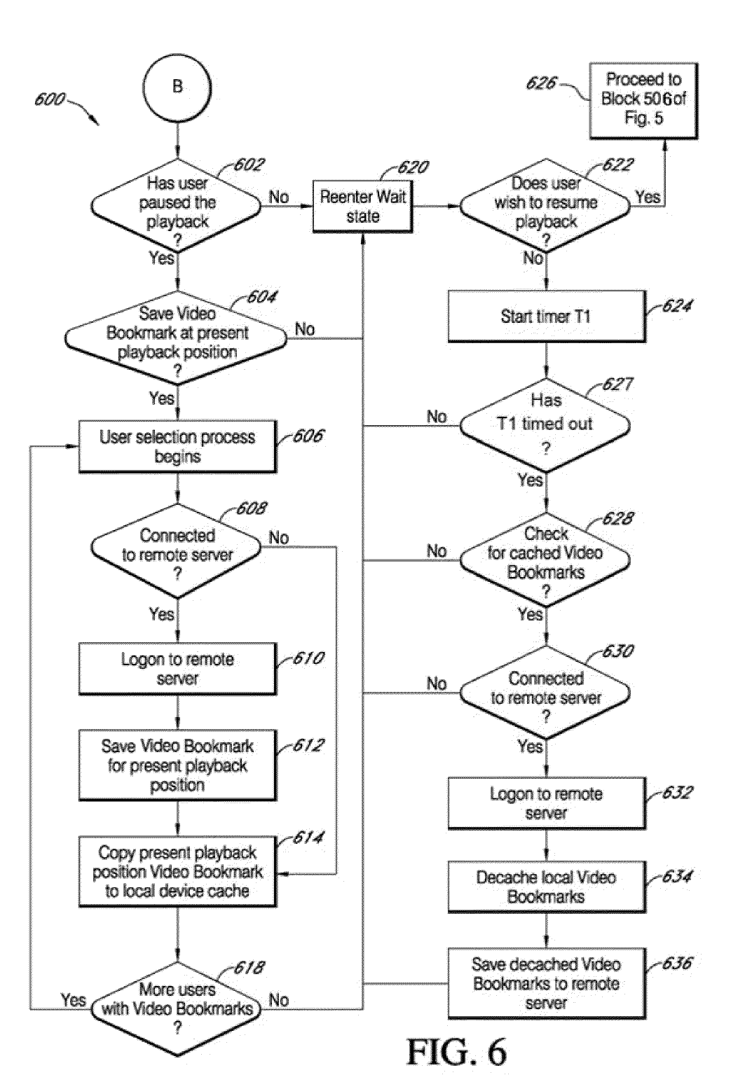

In an embodiment, during the playback, while in the wait state 414, if the user pauses the playback of the media content file 602 of FIG. 6, the user is presented with an option to save a video bookmark 604, thereby marking the present playback position in the media content file, for instance with a GUI on the playback device. If the user declines to create a video bookmark 604, the wait state 620 is entered and timer T1 is armed 624 (unless the user wishes to resume playback 622). In an embodiment, timer T1 controls how often the playback device attempts to save its playback state online when the playback session is paused.

In an embodiment, while in the wait state 620, if the user commands the device to resume the playback 622, the playback begins and the process enters the online check 506 previously described for saving the default user video bookmark. While in the wait state 620, if timer T1 expires 627, the device checks if there are any locally cached video bookmarks 628. If there are no cached video bookmarks, then the device reenters the wait state 620 where timer T1 is rearmed 624. When the timer T1 has not expired at block 627, the process holds in the wait state 620. However, if there are cached video bookmarks 628, the device checks if it is connected online to the server store 200 providing video bookmark web services 630 and if online the device logs on 632 with the server store 200 providing the video bookmark web service.

Then the playback device reads and clears the video bookmarks in the local cache 634 and saves them online at the server at block 636. Once the cached video bookmarks are saved, the process reenters the wait state 620 where timer T1 is rearmed 624. This sequence ensures that video bookmarks are cached locally 308 and saved online 206 whenever the user pauses the playback session.

In an embodiment, if a user accepts to create a video bookmark 604, a process is entered 606 where one or multiple users viewing the playback are presented the opportunity to save the current paused playback position in the media content file in a video bookmark. The user selection process 606 begins when the user is presented, for instance with a GUI on the playback device, with a list of user IDs associated with the playback device. In an embodiment, the list is assumed to be stored locally 308 and a selection process (not shown) may allow a user or groups of users to be added/deleted/renamed. Based on who is watching the playback session, the user selects the appropriate user identity for the video bookmark. The device then checks if it is online 608.

In an embodiment, if the playback device has only a single user associated with it (e.g. a laptop 124 or PDA 122) the video bookmark associated with the user and media content file is automatically selected without user intervention. If the device is online the device logs on 610 with the server store 200 to access the video bookmark web service. The server's video bookmark repository 206 is updated with the selected user's video bookmark 612 for the present playback position in the media content file. The device's local video bookmark cache 308 is also updated with a copy of the same video 614. The purpose of this video bookmark is to enable memory storage of the latest playback position in the media content file so that the user can resume playback at the last-paused playback position by using their video bookmark associated with the playback device.

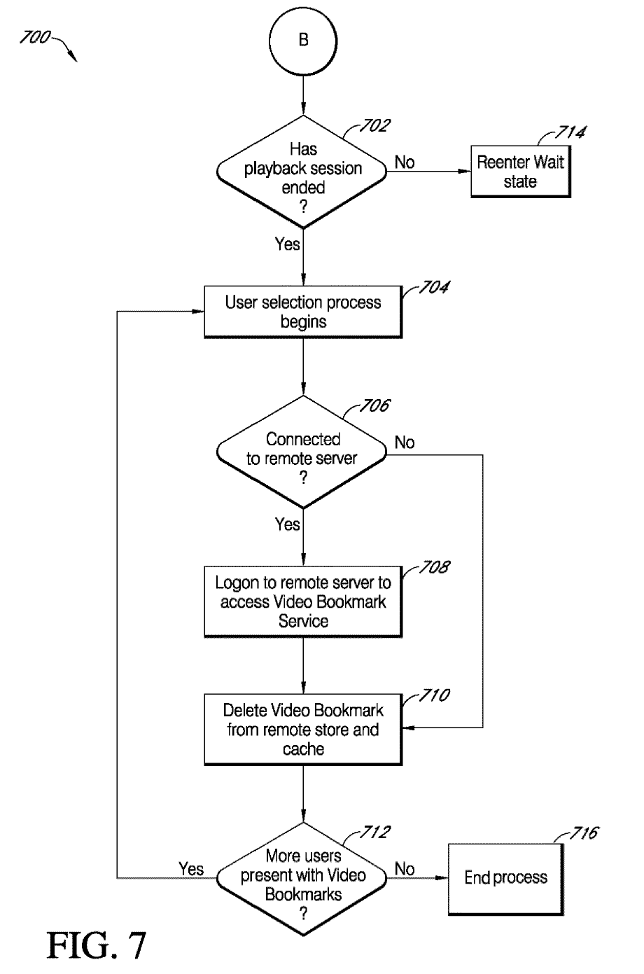

In an embodiment, if the playback device is offline, the device's local video bookmark cache 308 is updated with the video bookmark for the present playback position in the media content file using selected user ID associated with the playback device. When there are no more users that wish to define a video bookmark 618 the device logs off from the server store 200 if online and exits the video bookmark creation process and the process waits 620 for either T1 timeout 624 or the user to resume the playback 622. When the playback session finishes 702 of FIG. 7 at the end of the media content file, the playback device begins a sequence where the video bookmarks associated with the playback device and media content file are cleared beginning with user selection 704

In an embodiment, the user selection process 704 begins when the user is presented, for instance with a GUI on the playback device, with a list of user IDs associated with the playback device. The list is assumed to be stored locally 308 and a process (not shown) allows a user or groups of users to be added/deleted/renamed. Based on who is watching the playback session, the user may select the appropriate user identity for the video bookmark.

If the playback device has only a single user associated with it (e.g. a laptop 124 or a PDA 122) the video bookmark associated with the user and media content file is automatically selected 704 without user intervention. The playback device then checks if it is online and connected with the server store 200 at block 706. If the playback device is online, the playback device logs on 708 with the server store 200 to access the video bookmark web service. The server's 200 video bookmark repository 206 is updated and the selected user's video bookmark is deleted 710. The device also inspects the local video bookmark cache 308 and deletes any remaining video bookmarks for the selected user.

In an embodiment, the video bookmark clearing process repeats until there are no more users present that have finished watching the media content file 712, the user exits the selection loop (automatically if the device has only a single user associated with it) 714 and the process associated with the playback of the file ends after the device logs off the server if it is online 716.

In an alternate embodiment for implementing video bookmarks, various state information associated with video bookmarks could be kept on miniature portable storage media such as USB flash memory sticks. Since many playback devices now or in the future will feature interfaces to portable storage, users could carry their video bookmarks with them in a portable fashion. In this case the implementation of video bookmarks described above would be nearly the same except for the meaning of being connected online with the remote video bookmark server processes would change. In the case of portable storage, ‘online’ would mean that the storage media was connected physically or wirelessly into the playback device so that the video bookmarks stored on the storage media were accessible by the device. Since there would be no single master copy of the video bookmarks, as with an online web service implementation, use of portable storage video bookmark vaults would be limited to personal content libraries and personal playback viewing devices.

In accordance with several embodiments of the invention, the following operational scenarios are facilitated by different aspects of the present invention:

In accordance with a first scenario, a user begins watching a video from their home media content library 308 stored on their home DVR 116, but stops the playback for the night to prepare for a trip the following morning. The following day, the user grabs their laptop 124 and heads for the airport. At the airport the user resumes watching the playback on their laptop 124 while waiting briefly at the airport gate. The user shuts down the playback again and leaves for their destination. While in flight, the user resumes watching the playback but shuts down again for landing. The rest of the trip the user is busy working and does not resume playback until they return home again. The user turns on their DVR 116 and resumes watching the playback right where they last left off on the airplane.

In accordance with a second scenario, two users, A and B, live together and share a media content library 206, 308. A and B both enjoy the same television series and have the entire season resident in their media content library 206, 308. Having different schedules, they watch the series episodes at different rates. A and B can each pause and resume watching where they left off by accessing their personal video bookmarks. In an embodiment, this scenario may be analogous to two users reading the same book but using individual bookmarks to keep their place.

In accordance with a third scenario, two users, A and B, live together and share a media content library 206, 308. They begin to watch a video but pause at some point. While the playback is paused the users are presented the option to save a video bookmark for each user present according to a pre-populated list of users (e.g. family members) associated with the playback device. Later when A alone wishes to continue the playback, she is presented with the option to resume by selecting her video bookmark for the media content file according to a pre-populated list of users (e.g. family members) associated with the playback device. User B continues the playback on their personal video device which automatically knows to resume using B's video bookmark since only B is associated with the media playback device.

In accordance with a fourth scenario, two users, A and B, live together and share a media content library 206, 308. They begin to watch a video but A gets called away at some point. User B pauses the playback and is presented the option to save a video bookmark on A's behalf according to a pre-populated list of users (e.g. family members) associated with the media playback device. Later, before resuming playback, A can select their video bookmark from a list associated with the playback device for the media content file. User A finishes watching the video and their video bookmark is automatically cleared.

In an embodiment, video bookmarks may consist of state information that allows users to maintain their playback sessions across multiple playback devices while accessing a common media library of content files. In an embodiment, in order to accomplish this, video bookmarks may maintain information elements including: playback file position and digital rights management (DRM) key (optional). The playback file position may be implemented as any of various established ways of allowing a playback device to randomly seek a starting place to commence playback including a video frame index, playback time index, or similar method. In the case of a video frame index the video format would include imbedded, metadata, or calculated sequential frame indices in the content file. In the case of a playback time index the video format includes imbedded, metadata, or calculated time indices in the content file corresponding to positions in the file at a particular playback moment. The playback file position need not be exact for useful video bookmark scenarios, but could specify the position in the file to within one or two seconds during a playback session.

In an embodiment, the DRM key may be implemented in any of a variety of known ways of storing a short digital sequence that allows the playback device to decrypt an encrypted file prior to playback as a batch process, or in real time during playback. Another alternative to keeping DRM state information in the video bookmark would be to let each device independently obtain and manage sets of keys for locally stored content, in this case DRM may be independent of the video bookmarking mechanism.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed: are defined as follows:

1. A video content distribution system comprising:
a remote content server;
a communications network; and
a plurality of media playback devices,
wherein a first playback device of the plurality of media playback devices generates a first place marker that indexes a first location in a video content where to resume playback of the video content, and
wherein the first playback device stores the first place marker locally in a first portion of the communications network.

2. The video content distribution system of claim 1, wherein the first playback device connects to the remote content server and stores a copy of the first place marker in a second portion of the communications network.

3. The video content distribution system of claim 2, wherein the first portion of the communications network is a local area network (LAN) location and the second portion of the communications network is a wide area network (WAN) location.

4. The video content distribution system of claim 2, wherein a second playback device of the plurality of media playback devices accesses the copy of the first place marker and resumes playback of the video content at the indexed first location in the video content.

5. The video content distribution system of claim 4, wherein the second playback device generates a second place marker that indexes a second location in the video content and then stores the second place marker both locally on the second playback device and remotely as a copy on the remote content server.

6. The video content distribution system of claim 5, wherein the first playback device accesses the copy of the second place marker on the remote content server and resumes playback of the video content at the indexed second location in the video content.

7. The video content distribution system of claim 1, wherein the first playback device also stores a set of user access rights that comprise information pertaining to which users have access to which media content and which place markers.

8. A computer-readable medium encoded with computer executable instructions, which when executed, performs a method comprising:
generating at a first media playback device, a first place marker that indexes a first location in a video content where to resume playback of the video content; and
storing the first place marker locally in a first portion of a communications network in response to the generation of the first place marker.

9. The computer-readable medium of claim 8, wherein the method further comprises connecting the first media playback device to a remote content server and storing a copy of the first place marker in a second portion of the communications network.

10. The computer-readable medium of claim 9, wherein the first portion of the communications network is a local area network (LAN) location and the second portion of the communications network is a wide area network (WAN) location.

11. The computer-readable medium of claim 9, wherein the method further comprises a second media playback device accessing the copy of the first place marker and resuming playback of the video content at the indexed first location in the video content.

12. The computer-readable medium of claim 11, wherein the method further comprises
the second media playback device generating a second place marker that indexes a second location in the video content and then storing the second place marker both locally on the second playback device and remotely as a copy on the remote content server.

13. The computer-readable medium of claim 12, wherein the method further comprises the first media playback device accessing the copy of the second place marker on the remote content server and resuming playback of the video content at the indexed second location in the video content.

14. The computer-readable medium of claim 8, wherein the method further comprises the first media playback device storing a set of user access rights that comprise information pertaining to which users have access to which media content and which place markers.

15. A computer-implemented method comprising:
generating at a first media playback device, a first place marker that indexes a first location in a video content where to resume playback of the video content; and
storing the first place marker locally in a first portion of a communications network in response to the generation of the first place marker.

16. The computer-implemented method of claim 15, wherein the method further comprises connecting the first media playback device to a remote content server and storing a copy of the first place marker in a second portion of the communications network.

17. The computer-implemented method of claim 16, wherein the first portion of the data communications network is a wide area network (WAN) and the second portion of the data communications network is a local area network (LAN).

18. The computer-implemented method of claim 16, wherein the method further comprises a second media playback device accessing the copy of the first place marker and resuming playback of the video content at the indexed first location in the video content.

19. The computer-implemented method of claim 18, wherein the method further comprises the second media playback device generating a second place marker that indexes a second location in the video content and then storing the second place marker both locally on the second playback device and remotely as a copy on the remote content server.

20. The computer-implemented method of claim 19, wherein the method further comprises the first media playback device accessing the copy of the second place marker on the remote content server and resuming playback of the video content at the indexed second location in the video content.
